(19) United States
(12) Patent Application Publication
(10) Pub. No.: US 2021/0088548 A1
(43) Pub. Date: Mar. 25, 2021

(54) MICROMECHANICAL INERTIAL SENSOR

(71) Applicant: Robert Bosch GmbH, Stuttgart (DE)

(72) Inventors: Stefan Kiesel, Reutlingen (DE); Jochen Beintner, Reutlingen (DE); Monika Koster, Reutlingen (DE)

(21) Appl. No.: 17/054,463

(22) PCT Filed: Aug. 6, 2019
(86) PCT No.: PCT/EP2019/071078

§ 371 Date: Nov. 10, 2020

(30) Foreign Application Priority Data
Aug. 15, 2018 (DE) 10 2018 213 746.3

(51) Int. Cl. G01P 15/08; G01P 1/00; G01P 3/44; G01P 15/18

(52) U.S. Cl. CPC G01P 15/08; G01P 15/18; G01P 3/44; G01P 1/00

(57) ABSTRACT

A micromechanical inertial sensor that includes a substrate, and at least two identical z sensor cores, each including a movable asymmetrical seismic mass. The movable asymmetrical seismic masses are each twistable about a torsion axis. The two z sensor cores are situated on the substrate rotated by 180° relative to one another.

### FIELD

The present invention relates to a micromechanical inertial sensor. Moreover, the present invention relates to a method for manufacturing a micromechanical inertial sensor.

### BACKGROUND INFORMATION

Conventional micromechanical acceleration sensors and inertial sensors generally include MEMS structures.

The movable MEMS structures (seismic mass) manufactured in this way are generally sealed with a cap wafer in the further process sequence. Depending on the application, a suitable internal pressure is enclosed within the volume thus closed off, the closure usually taking place via a seal glass bonding process or via a eutectic bonding process using AlGe, for example.

To manufacture a z acceleration sensor in such a manufacturing process, a rocker structure that is anchored to the substrate via torsion springs is formed in the micromechanical functional layer. The mass distribution of the rocker structure has an asymmetrical design, two electrode surfaces being situated beneath the rocker structure to allow a deflection of the rocker structure to be capacitively ascertained by measurement.

One disadvantage of this system is that the rockers designed in this way are subject to a thermal offset effect which may exert a force on one side of the rocker. This is the case in particular when the thermal expansion is characterized in such a way that the two rocker sides are subject to different thermal effects. A traditional optimization of a z rocker in the high-mass side and the low-mass side does not eliminate this error if the thermal insulation is different on the low-mass side and on the high-mass side.

When a vertical temperature gradient is present at the z inertial sensor, a radiometric effect develops in the sensor. The gas atoms coming from the cold side have a lower velocity than the gas atoms from the warm side, forces being exerted on the movable mass due to impacts of these atoms of different velocities, with movable masses.

The conventional z inertial sensor described above, including an asymmetrical rocker, responds very strongly to such gas dynamics, in the form of an undesirable deflection of the rocker. Even a symmetrical rocker responds to a temperature gradient. This may be explained by the fact that perforation holes between the light side and the heavy side of the rocker differ in layer thickness, resulting there in different momentum transfers of the gas atoms, which induce a force.

For a defined internal pressure and a target temperature, the size of the particular perforation may be adapted in such a way that both sides are in equilibrium. However, any change in temperature or pressure brings the z inertial sensor out of equilibrium.

### SUMMARY

An object of the present invention is to provide a micromechanical inertial sensor that avoids the disadvantages stated above.

According to a first aspect of the present invention, the object may be achieved with a micromechanical inertial sensor according to an example embodiment of the present invention. An example embodiment of the present invention provides a micromechanical inertial sensor that includes:
a substrate;
at least two identical z sensor cores, each including a movable asymmetrical seismic mass, the movable asymmetrical seismic masses each being twistable about a torsion axis;
characterized in that the two z sensor cores are situated on the substrate rotated by 180° relative to one another.

A micromechanical inertial sensor is thus provided which may sense in the z direction. Due to the arrangement of the two sensor cores rotated by 180°, an improved evaluation of sensor signals may take place due to the fact that heat flows, which have an adverse radiometric effect on the seismic mass, may be eliminated or at least greatly reduced. An offset error and/or rotatory effects may thus advantageously be compensated for.

According to a second aspect of the present invention, the object may be achieved with a method for manufacturing a micromechanical inertial sensor in accordance with an example embodiment of the present invention. In an example embodiment of the present invention, the method includes the steps:
providing a substrate;
providing at least two identical z sensor cores, each including a movable asymmetrical seismic mass on the substrate, the movable asymmetrical seismic masses each being situated twistably about a torsion axis, the two z sensor cores being situated on the substrate rotated by 180° relative to one another.

Preferred refinements of the micromechanical inertial sensor in accordance with the present invention are described herein.

One advantageous refinement of the micromechanical inertial sensor in accordance with the present invention also includes two x sensor cores and/or two y sensor cores. A micromechanical inertial sensor is thus provided which may sense in all Cartesian coordinates x, y, z.

In a further advantageous refinement of the micromechanical inertial sensor in accordance with the present invention, output signals of at least a portion of the sensor cores are separately guided outwardly. In this way, an electronic evaluation circuit may be controlled with signals of the sensor cores according to a fully differential concept.

In a further advantageous refinement of the micromechanical inertial sensor in accordance with the present invention, output signals of at least a portion of the sensor cores are combined within the inertial sensor and outwardly guided in combined form. A single-ended signal concept is thus implemented. This is achieved in that sensor signals or sensor lines are already wired within the micromechanical inertial sensor; the sensor signal as a single signal is guided outwardly to the electronic evaluation circuit.

Further advantageous refinements of the micromechanical inertial sensor in accordance with the present invention provide that the micromechanical inertial sensor is an acceleration sensor or a rotation rate sensor. In this way, different sensor applications may advantageously be covered using the micromechanical inertial sensor.

The present invention is described in greater detail below with regard to further features and advantages, with reference to three figures. Identical or functionally equivalent elements have the same reference numerals. The figures are in particular intended to explain the main principles of the present invention, and are not necessarily illustrated true to scale. For better clarity, it may be provided that not all reference numerals are shown in all figures.

Provided method features analogously result from corresponding provided device features, and vice versa. This means in particular that features, technical advantages, and statements regarding the method for manufacturing a micromechanical inertial sensor analogously result from corresponding features, advantages, and statements regarding the micromechanical inertial sensor, and vice versa.

### BRIEF DESCRIPTION OF THE DRAWINGS

FIG. 1 shows a schematic top view onto a first specific embodiment of the provided micromechanical inertial sensor in accordance with the present invention.

FIG. 2 shows a top view onto a second specific embodiment of the provided micromechanical inertial sensor in accordance with the present invention.

FIG. 3 shows a schematic sequence of a method for manufacturing a provided micromechanical inertial sensor in accordance with an example embodiment of the present invention.

### DETAILED DESCRIPTION OF EXAMPLE EMBODIMENTS

The present invention provides a micromechanical inertial sensor that is significantly less sensitive to radiometric effects.

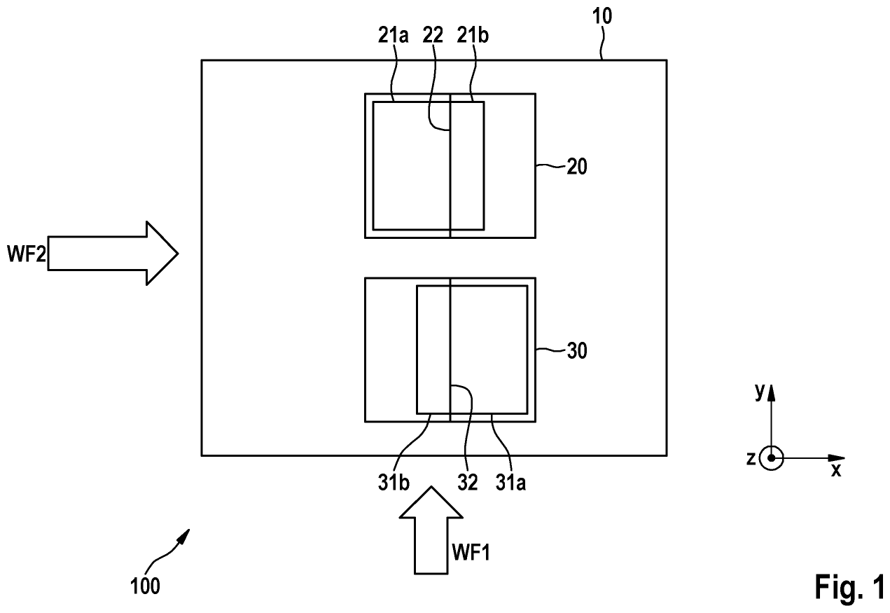

FIG. 1 shows a schematic top view onto a first specific embodiment of provided micromechanical inertial sensor 100 in accordance with the present invention.

A substrate 10, for example in the form of a circuit board, is apparent on which a first z sensor core 20 and a second, identical z sensor core 30 are situated, preferably soldered. The two z sensor cores 20, 30 are situated on substrate 10 rotated by 180° relative to one another, each of the two sensor cores 20, 30 including seismic masses having an asymmetrical design. A high-mass portion 21a and a low-mass portion 21b of the asymmetrical seismic mass of first z sensor core 20 are twistable about a torsion axis 22. A high-mass portion 31a and a low-mass portion 31b of the seismic mass of second z sensor core 30 are twistable about a torsion axis 32. The two z sensor cores 20, 30 are provided for detecting deflections of their seismic masses in the z direction.

A direction of a first heat flow WF1, which acts in the y direction on substrate 10 including the two z sensor cores 20, 30, is apparent. As the result of a heat gradient along the direction of heat flow WF1, caused by heat flow WF1 and brought about, for example, by different temperatures of connecting pins (not illustrated) of an electronic evaluation circuit (not illustrated), the high-mass portions and the low-mass portions of the seismic masses of the two z sensor cores 20, 30 are acted on at the same temperature and are thus compensated for. This is achieved in that the temperature gradient effectuated by heat flow WF1 affects the high-mass portions and the low-mass portions of the seismic mass in the identical manner.

Also indicated is a second heat flow WF2 which acts on the two z sensor cores 20, 30 in the x direction. In this case, in the presence of only a single z sensor core 20, 30 the low-mass portion and the high-mass portion of the seismic mass would have different temperatures due to the temperature gradient caused by the heat flow, as the result of which a thermal offset effect (“radiometric effect”) is generated which produces a deflection of the seismic mass and thus an undesirable measuring signal of single z sensor core 20, 30.

The radiometric effect is produced by an energy transfer that acts in a cavity which encloses the seismic masses under a defined gas pressure; as a result of this energy transfer, gas particles moved within the cavity effectuate an action of force, or an undesirable deflection of the seismic masses.

It is therefore provided to situate a second z sensor core 30 on substrate 10, rotated by 180° relative to first z sensor core 20, or to manufacture same in the micromechanical process, thereby compensating for or at least reducing the above-described disadvantageous effects of heat flow WF2. The directions of the two heat flows WF1, WF2 indicated in FIG. 1 are shown strictly by way of example, it being possible to compensate for effects of all heat flows, with resulting radiometric effects, via the arrangement according to the present invention of z sensor cores 20, 30 on substrate 10.

It is thus possible for the radiometric effect resulting from heat flows to be eliminated or at least greatly reduced, and for a deflection of the z rocker structures of z sensor cores 20, 30 to be effectuated solely by mechanical forces.

As a result, provided micromechanical inertial sensor 100 is advantageously also less sensitive to bending of substrate 10, which results, for example, when inertial sensor 100 is attached (for example, glued, etc.) to substrate 10 and is thus subjected to temperature fluctuations or mechanical tensions. In addition, so-called “bias drifts,” i.e., changes in signals over time, that are generated due to heat sources and thus adversely affect the system, may advantageously be eliminated or at least greatly reduced in provided micromechanical inertial sensor 100. The stated bias drift may be generated, for example, by a powerful microcomputer in a mobile terminal (mobile telephone, for example) which, depending on the application running on it, generates different amounts of heat over time, which has an adverse effect on sensitive micromechanical structures.

The offset behavior of a provided micromechanical inertial sensor 100 may thus be greatly improved.

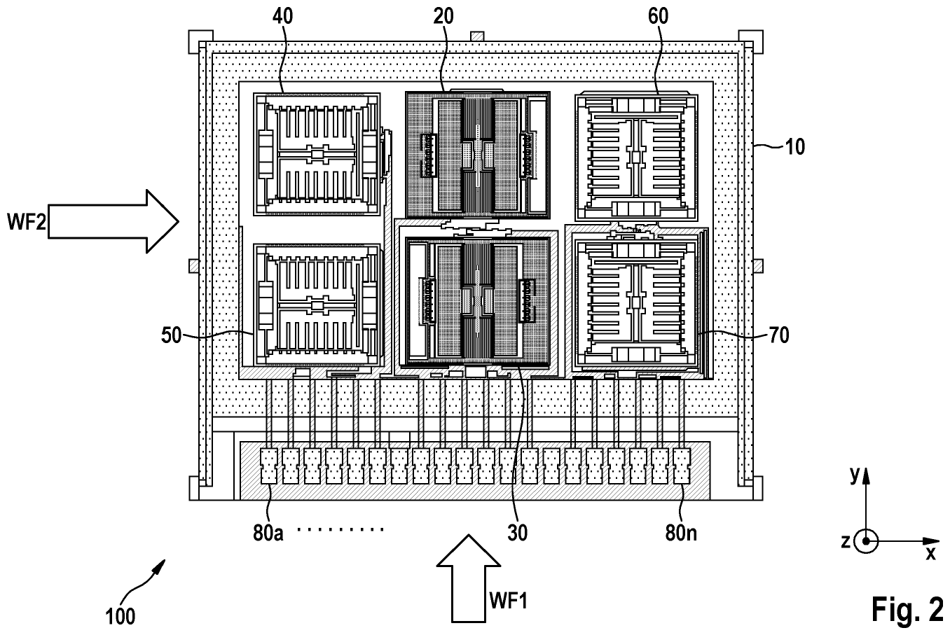

FIG. 2 shows a top view onto a further specific embodiment of provided micromechanical inertial sensor 100 in accordance with the present invention. In this case, in addition to the two stated z sensor cores 20, 30, lateral sensor cores in the form of two identical x sensor cores 40, 50 (for the x channel) and two identical y sensor cores 60, 70 (for the y channel) are also situated on substrate 10 or manufactured in the micromechanical process. In this way, a micromechanical inertial sensor 100 in the form of a rotation rate sensor and/or an acceleration sensor may be advantageously implemented for all Cartesian coordinates x, y, z. Geometric orientations of the stated additional lateral sensor cores with respect to one another on substrate 10 are arbitrary.

Also apparent in FIG. 2 are a total of twenty connecting pins 80a . . . 80n, via which an electronic evaluation circuit (for example, in the form of an ASIC, not illustrated) is attached to the sensor cores and with the aid of which signals of sensor cores 20, 30, 40, 50, 60, 70 are evaluated. It may be provided that the signals of at least two mutually associated sensor cores 20, 30, 40, 50, 60, 70 (i.e., sensor cores of the x channel and/or of the y channel and/or of the z channel) are already wired within micromechanical inertial sensor 100 and guided outwardly in area 80a . . . 80n via, for example, only three connecting pins per each sensor direction x, y, z (in a single-ended manner).

Alternatively, it may also be provided that signals of at least two mutually associated sensor cores 20, 30, 40, 50, 60, 70 are guided outwardly via a dedicated connecting pin 80a . . . 80n in each case, as the result of which a fully differential sensor principle is implemented.

The type of sensor principle applied depends in particular on the type of electronic evaluation circuit used for micromechanical inertial sensor 100.

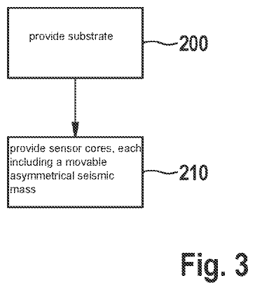

FIG. 3 shows a schematic sequence of the provided method for manufacturing a micromechanical inertial sensor 100 in accordance with an example embodiment of the present invention.

Provision of a substrate 10 is carried out in a step 200.

Provision of at least two identical z sensor cores 20, 30, each including a movable asymmetrical seismic mass 21a, 21b, 31a, 31b, on substrate 10 is carried out in a step 210, movable asymmetrical seismic masses 21a, 21b, 31a, 31b in each case being designed to be twistable about a torsion axis 22, 32, the two z sensor cores 20, 30 being situated on substrate 10 rotated by 180° relative to one another.

It is understood as a matter of course that the order of the substeps of step 210 may also be interchanged in a suitable manner.

In summary, with the present invention a micromechanical inertial sensor is provided which is optimized with regard to thermal offset error and/or rotational/vibrational offset error and/or offset error related to substrate bending.

Although the present invention has been described above with reference to specific exemplary embodiments, those skilled in the art may also implement specific embodiments that are not described or only partly described above, without departing from the present invention.

1-10 (canceled)

11. A micromechanical inertial sensor, comprising:
a substrate;
at least two identical z sensor cores, each including a movable asymmetrical seismic mass, the movable asymmetrical seismic masses each being twistable about a torsion axis, wherein the two z sensor cores are situated on the substrate rotated by 180° relative to one another.

12. The micromechanical inertial sensor as recited in claim 11, further comprising:
two x sensor cores and/or two y sensor cores.

13. The micromechanical inertial sensor as recited in claim 12, wherein output signals of at least a portion of: the two z sensor cores, and the two x sensor cores and/or the two y sensor cores are separately guided outwardly.

14. The micromechanical inertial sensor as recited in claim 12, wherein output signals of at least a portion of: the two z sensor cores, and the two x sensor cores and/or the two y sensor cores, are combined within the inertial sensor and outwardly guided in combined form.

15. The micromechanical inertial sensor as recited in claim 11, wherein the micromechanical inertial sensor is an acceleration sensor or a rotation rate sensor.

16. A method for manufacturing a micromechanical inertial sensor, comprising the following steps:
providing a substrate; and
providing at least two identical z sensor cores, each including a movable asymmetrical seismic mass, on the substrate, the movable asymmetrical seismic masses each being designed to be twistable about a torsion axis, the two z sensor cores being situated on the substrate rotated by 180° relative to one another.

17. The method as recited in claim 16, further comprising:
providing, on the substrate, two x sensor cores and/or two y sensor cores.

18. The method as recited in claim 16, wherein signals of at least two mutually associated ones of the Z sensor cores are wired within the micromechanical inertial sensor and guided outwardly.

19. The method as recited in claim 16, wherein signals of at least two mutually associated ones of the Z sensor cores are separately guided outwardly.

20. The method as recited in claim 16, further comprising:
using the micromechanical inertial sensor as a rotation rate sensor or as an acceleration sensor.
